(19) United States
(12) Patent Application Publication
(10) Pub. No.: US 2016/0025902 A1
(43) Pub. Date: Jan. 28, 2016

(54) OPTICAL DEVICE

(71) Applicant: KABUSHIKI KAISHA TOSHIBA, Tokyo (JP)

(72) Inventors: Kazuo HORIUCHI, Kanagawa (JP); Takashi Sasaki, Kanagawa (JP)

(73) Assignee: KABUSHIKI KAISHA TOSHIBA, Tokyo (JP)

(21) Appl. No.: 14/808,518

(22) Filed: Jul. 24, 2015

(30) Foreign Application Priority Data
Jul. 25, 2014 (JP) 2014-151434

(51) Int. Cl. G02B 3/08

(52) U.S. Cl. CPC G02B 3/08

(57) ABSTRACT

According to one embodiment, an optical device includes first and second optical elements. The first optical element is disposed on a display surface. The first optical element includes first and second surfaces. A first light emitted from the display surface is incident on the first surface. The first optical element includes transmissive portions and non-transmissive portions. Each of the transmissive portions extends in a first direction parallel with the first surface. Each of the non-transmissive portions is disposed between the transmissive portions. A light transmittance of the non-transmissive portions is lower than that of the transmissive portions. A second light emitted from the second surface is incident on the second optical element, which emits the second light as a third light. An optical axis of the third light is tilted with respect to an optical axis of the second light in a plane perpendicular to the second direction.

### CROSS-REFERENCE TO RELATED APPLICATIONS

This application is based upon and claims the benefit of priority from Japanese Patent Application No.2014-151434, filed on Jul. 25, 2014; the entire contents of which are incorporated herein by reference.

### FIELD

Embodiments described herein relate generally to an optical device.

### BACKGROUND

A display device is provided in a portable communication device, a computer, or the like. A new application of such a display is desired.

### BRIEF DESCRIPTION OF THE DRAWINGS

FIG. 1 is a schematic perspective view illustrating an optical device according to a first embodiment;

FIG. 2 is a schematic cross-sectional view illustrating the optical device according to the first embodiment;

FIG. 3 is a schematic cross-sectional view illustrating an optical device according to a first embodiment;

FIG. 4 is a schematic perspective view illustrating an optical device according to a second embodiment;

FIG. 5 is a schematic cross-sectional view illustrating the optical device according to the second embodiment;

FIG. 6 is a schematic cross-sectional view illustrating the optical device according to the second embodiment;

FIG. 7 is a schematic plan view illustrating the optical device according to the second embodiment;

FIG. 8 is a schematic plan view illustrating the optical device according to the second embodiment;

FIGS. 9A and 9B are graphs illustrating characteristics of the optical device according to the second embodiment;

FIGS. 10A and 10B are schematic diagrams illustrating the optical device according to the second embodiment;

FIG. 11 is a schematic cross-sectional view illustrating an optical device according to a third embodiment;

FIG. 12 is a schematic cross-sectional view illustrating the optical device according to the third embodiment;

FIG. 13 is a schematic perspective view illustrating an optical device according to a fourth embodiment; and

FIG. 14 is a schematic cross-sectional view illustrating a using state of the optical device according to the embodiment.

### DETAILED DESCRIPTION

According to one embodiment, an optical device includes a first optical element and a second optical element. The first optical element is disposed on a display surface of a display. The first optical element includes a first surface and a second surface. A first light emitted from the display surface is incident on the first surface. A second surface is opposite to the first surface. The first optical element includes a plurality of transmissive portions and a plurality of non-transmissive portions. Each of the transmissive portions extends in a first direction parallel with the first surface. The transmissive portions are arranged in a second direction perpendicular to the first direction and parallel with the first surface. Each of the non-transmissive portions is disposed between the transmissive portions. A light transmittance of the non-transmissive portions is lower than a light transmittance of the transmissive portions. A second optical element is disposed on the first optical element. A second light emitted from the second surface is incident on the second optical element. The second optical element emits the second light as a third light. The second optical element causes an optical axis of the third light to be tilted with respect to an optical axis of the second light in a plane perpendicular to the second direction.

Various, embodiments according to the invention will be described hereinafter with reference to the accompanying drawings.

The drawings are illustrated schematically or conceptually, and a relationship between the thickness and the width of each part, a ratio of sizes between parts, and the like are not necessarily limited to being the same as those in the real world. Although the same part is represented, dimensions or ratios of the same parts in the drawings may be different from each other.

In the application specification and the drawings, the same components as those described already with reference to the aforementioned drawing are denoted by the same reference numerals and detailed descriptions thereof will be appropriately omitted.

### First Embodiment

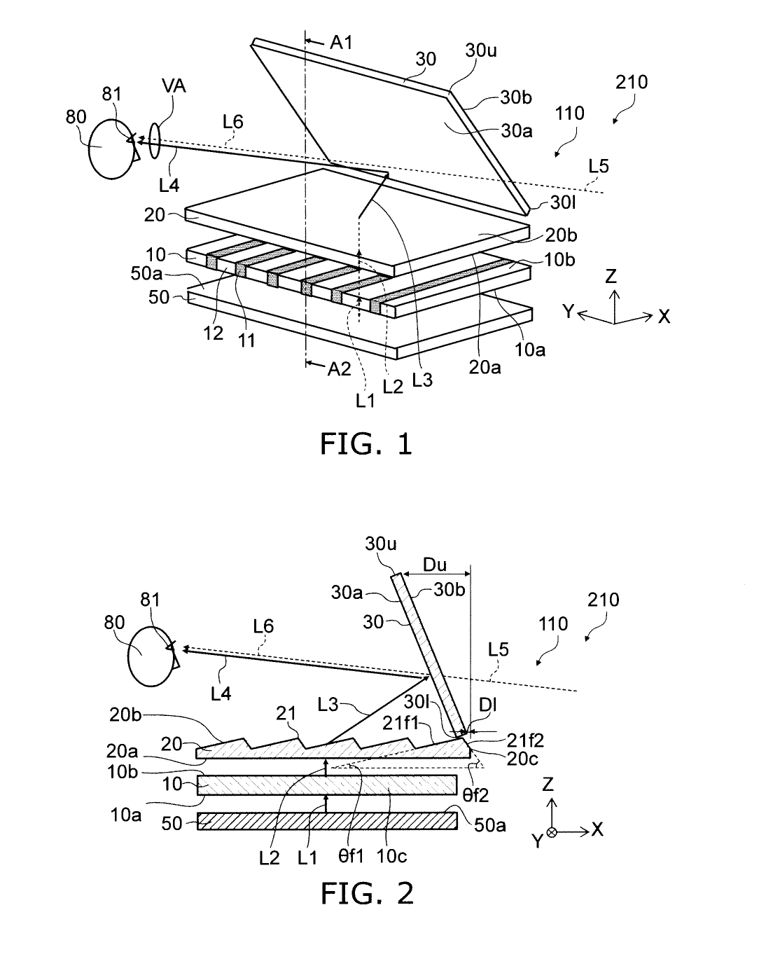

FIG. 1 is a schematic perspective view illustrating an optical device according to a first embodiment.

FIG. 2 is a schematic cross-sectional view illustrating the optical device according to the first embodiment.

FIG. 2 is a cross-sectional view taken along line A1-A2 in FIG. 1.

As illustrated in FIGS. 1 and 2, an optical device 110 according to the embodiment includes a first optical element 10 and a second optical element 20. In this example, a third optical element 30 is provided. The third optical element 30 may be included in the optical device 110 or be provided separately from the optical device 110.

The optical device 110 is used along with a display 50. For example, the optical device 110 is disposed on the display 50. The display 50 and the optical device 110 are included in a display system 210.

The display 50 corresponds to a portable display, for example. As the display 50, a portable communication device (cellphone, smartphone, and the like), a portable personal computer, or the like is used. The display 50 includes a display singleton which outputs image information from the outside of the display. In the embodiment, as the display 50, any device may be used.

The display 50 has a display surface 50a. A light (first light L1) including a display image is emitted from the display surface 50a.

The first optical element 10 is disposed on the display surface 50a of the display 50, for example.

The first optical element 10 has a first surface 10a and a second surface 10b. A first light L1 emitted from the display surface 50a is incident to the first surface 10a. The second surface 10b is different from the first surface 10a. The second surface 10b is opposite to the first surface 10a. The first light L1 is incident to the first surface 10a, passes through the first optical element 10, and then is emitted from the second surface 10b. A light emitted from the second surface 10b is set as a second light L2.

The first optical element 10 includes a plurality of transmissive portions 12 and a plurality of non-transmissive portions 11. Each of the plurality of transmissive portions 12 is extended along a first direction. The first direction refers to a direction parallel with the first surface 10a. The plurality of transmissive portions 12 is arranged in a second direction. The second direction is parallel with the first surface 10a and is perpendicular to the first direction.

The first direction is set to be an X-axis direction. The second direction is set to be a Y-axis direction. A direction perpendicular to the X-axis direction and the Y-axis direction is set to be a Z-axis direction.

Each of the plurality of non-transmissive portions 11 is disposed between the plurality of transmissive portions 12. A light transmittance of the plurality of non-transmissive portions 11 is lower than a light transmittance of the plurality of transmissive portions 12.

The transmissive portion 12 is an opening, for example. The non-transmissive portion 11 is a light blocking portion, for example. A diffusion direction of the second light L2 emitted from the first optical element 10 is different from the first direction (X-axis direction) and the second direction (Y-axis direction). Diffusion of the second light L2 along the second direction is narrower than diffusion of the second light L2 along the first direction by the first light L1 passing through the first optical element 10. An example of a configuration and characteristics of the first optical element 10 will be described later.

The second optical element 20 is disposed on the first optical element 10. The second light L2 which is emitted from the second surface 10b of the first optical element 10 is incident to the second optical element 20. The second optical element 20 has a third surface 20a and a fourth surface 20b. The third surface 20a faces the second surface 10b. The third surface 20a is substantially parallel to an X-Y plane, for example. The second light L2 is incident to the third surface 20a. The fourth surface 20b is different from the third surface 20a. The fourth surface 20b is opposite to the third surface 20a. The light (second light L2) which is incident to the third surface 20a passes through the second optical element 20 and is emitted from the fourth surface 20b. The light emitted from the fourth surface 20b is set as a third light L3.

The second optical element 20 causes an optical axis of the third light L3 to be tilted with respect to an optical axis of the second light L2. An inclination direction is in a plane (X-Z plane) perpendicular to the second direction.

For example, the optical axis of the third light L3 is tilted (not parallel) with respect to the optical axis of the second light L2. The optical axis of the third light L3 and the optical axis of the second light L2 are parallel with the plane (X-Z plane) which is perpendicular to the second direction. In this example, the optical axis passes through the center of each component.

For example, a prism may be used in the second optical element 20. The second optical element 20 includes a plurality of protruding portions 21. The plurality of protruding portions 21 is provided on at least one of the third surface 20a and the fourth surface 20b. The plurality of protruding portions 21 forms a prism. That is, each of the plurality of protruding portions 21 includes a first tilted surface 21f1 and a second tilted surface 21f2. The first tilted surface 21f1 is tilted with respect to the first surface 10a and is disposed along the second direction. The second tilted surface 21f2 is tilted with respect to the first surface 10a, intersects with the first tilted surface 21f1, and is disposed along the second direction. An angle θf1 between the first surface 10a and the first tilted surface 21f1 is different from an angle θf2 between the first surface 10a and the second tilted surface 21f2. With this, it is possible to change a direction of the optical axis in the second optical element 20.

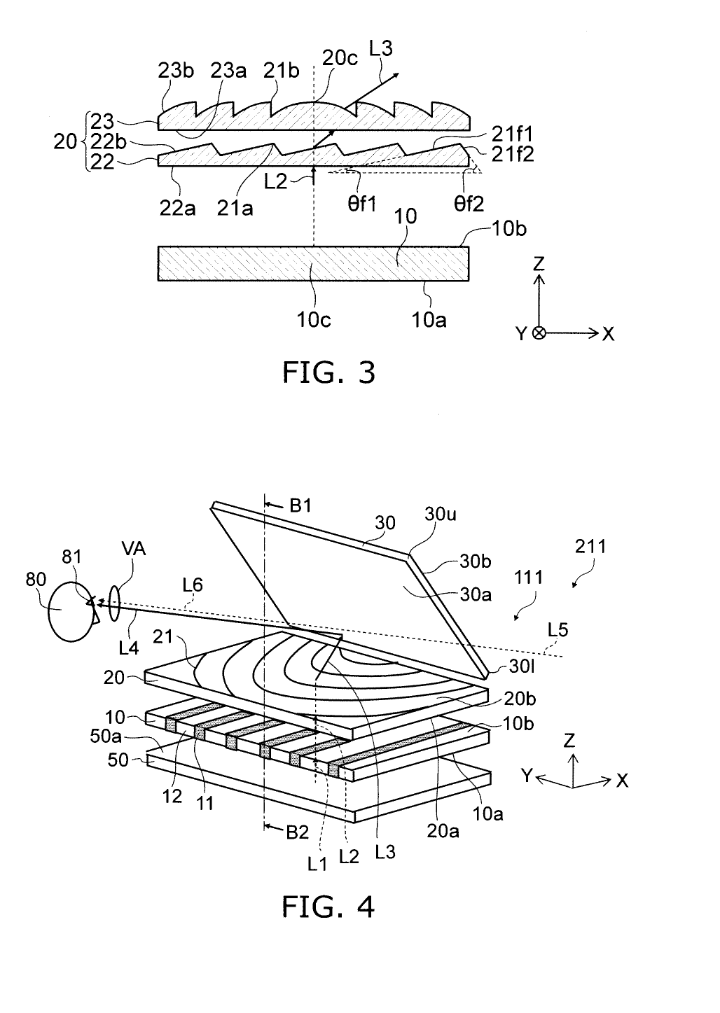

FIG. 3 is a partial cross-sectional view illustrating another example of the cross-section taken along line A1-A2 in FIG. 1.

As illustrated in FIG. 3, the second optical element 20 includes a first part 22 and a second part 23. The first part 22 has a third surface 22a to which the second light L2 is incident and a fourth surface 22b which is opposite to the third surface 22a. The second part 23 has a fifth surface 23a which faces the fourth surface 22b and a sixth surface 23b which is opposite to the fifth surface 23a. The first part 22 includes a plurality of first protruding portions 21a which is provided on at least one of the third surface 22a and the fourth surface 22b. The second part 23 includes a plurality of second protruding portions 21b which is provided on at least one of the fifth surface 23a and the sixth surface 23b.

The plurality of first protruding portions 21a forms a prism. That is, each of the plurality of first protruding portions 21a includes the first tilted surface 21f1 and the second tilted surface 21f2, similarly to the example in FIG. 2. The first tilted surface 21f1 is tilted with respect to the first surface 10a and is disposed along the second direction. The second tilted surface 21f2 is tilted with respect to the first surface 10a, intersects with the first tilted surface 21f1, and is disposed along the second direction. The angle θf1 between the first surface 10a and the first tilted surface 21f1 is different from the angle θf2 between the first surface 10a and the second tilted surface 21f2. The plurality of second protruding portions 21b forms a Fresnel lens. That is, each of the plurality of second protruding portions 21b has an arc shape when being projected on the third surface 22a (see FIG. 8 which will be described later).

In this case, for example, when the second optical element 20 is projected on a plane which includes the first direction and the second direction of the first optical element 10, the center 10c of the plane and an optical center 20c of the second part 23 (Fresnel lens) may be disposed to be overlapped. In this manner, the second optical element 20 may have a function to condense the light using the Fresnel lens in addition to a function to change a direction of the optical axis using the prism.

The first part 22 and the second part 23 may be reversely stacked. That is, the second part 23 may be disposed on the first optical element 10 side and the first part 22 may be provided on the second part 23.

The third light L3 which is tilted by the second optical element 20 is incident to the third optical element 30 and is reflected by the third optical element 30 to reach a viewer 80. The viewer 80 observes the display 50 (display system 210). The viewer 80 corresponds to a user of the optical device 110. The third optical element 30 is a combiner, for example.

That is, the second optical element 20 is directed toward the third optical element 30 which is provided to be tilted with respect to the first surface 10a, and emits the third light L3.

The third optical element 30 has a seventh surface 30a and an eighth surface 30b. The eighth surface 30b is opposite to the seventh surface 30a.

The third light L3 emitted from the second optical element 20 is reflected by the seventh surface 30a. The light reflected by the seventh surface 30a is set as a fourth light L4. The fourth light L4 travels toward the viewer 80. That is, the third light L3 is reflected by the third optical element 30 and then is incident on the viewer.

For example, the fourth light L4 which is reflected by the seventh surface 30a is incident on one eye 81 of the viewer 80. The fourth light L4 is not incident on the other eye of the viewer 80.

The viewer 80 visually recognizes the incident fourth light L4 with only the one eye 81 and does not visually recognize the incident fourth light L4 with the other eye. Perception of depth is augmented by performing visual recognition with only one eye. Parallax is not generated and thus it is easy to see the display.

In this manner, the third optical element 30 has reflexibility. The third optical element 30 may have optical transparency. That is, the third optical element 30 may have semitransmission reflexibility.

In this case, a fifth light L5 including a background image passes through the third optical element 30. For example, the fifth light L5 which is incident to the eighth surface 30b and includes the background image passes through the third optical element 30 and is emitted from the seventh surface 30a. A sixth light L6 emitted from the seventh surface 30a travels toward the viewer 80. The sixth light L6 is incident on both of the one eye 81 and the other eye of the viewer 80.

In the display system 210, a display image emitted from the display 50 is incident on the one eye 81 of the viewer 80 and is not incident on the other eye. On the contrary, the background image is incident on both of the eyes of the viewer. The viewer 80 observes the display image which is superposed on the background image. Since the background image is observed with both of the eyes, depth is perceived. However, since the display image which is superposed on the background image is observed with only the one eye 81, the display image is easily perceived at a depth position of the background image on which superposition is performed. That is, perception relating to depth is augmented in the display image.

In this manner, in the embodiment, a new application of the display 50 can be made in addition to a general use method of directly observing the display 50. In this new application, the display image is reflected by the third optical element 30, is superposed on the background image, for example, and is perceived.

The display 50 is desired to be mounted substantially horizontally when viewed from the viewer 80. The third optical element 30 is mounted so as to be tilted from a horizontal plane, in order to reflect the light emitted from the display 50. In the optical device 110 according to the embodiment, the first optical element 10 and the second optical element 20 are disposed between such a display 50 and the third optical element 30.

The second optical element 20 causes the light from the display 50 which is disposed substantially horizontally to be incident toward the third optical element 30. That is, the optical axis is tilted.

With this, it is possible to cause the light from the display 50 which is disposed horizontally to be incident to the third optical element 30, to be reflected, and to be incident to the viewer 80.

In the embodiment, for example, the display image is perceived with only the one eye 81. For this reason, diffusion of the light (fourth light L4) which is incident to the viewer 80, in a crosswise direction becomes small.

For example, the first optical element 10 includes the plurality of transmissive portions 12 and the plurality of non-transmissive portions 11. With this, the first optical element 10 may control diffusion of the light (first light L1) from the display 50 to reduce diffusion in the crosswise direction (corresponding to the second direction). Accordingly, it is possible to cause diffusion of the light (fourth light L4) which is incident to the viewer 80, in the crosswise direction to become narrow and the light may be incident on only the one eye 81 of the viewer 80.

In this manner, the first optical element 10 controls diffusion of the light and diffusion of the light becomes narrow. The second optical element 20 may have a function of condensing. That is, diffusion of the light also becomes narrow in the second optical element 20. In this manner, it is possible to cause the light (fourth light L4) which is incident to the viewer 80 to have a narrow width in the crosswise direction by causing diffusion of the light to become narrow using the second optical element 20 in addition to the first optical element 10.

### Second Embodiment

FIG. 4 is a schematic perspective view illustrating an optical device according to a second embodiment.

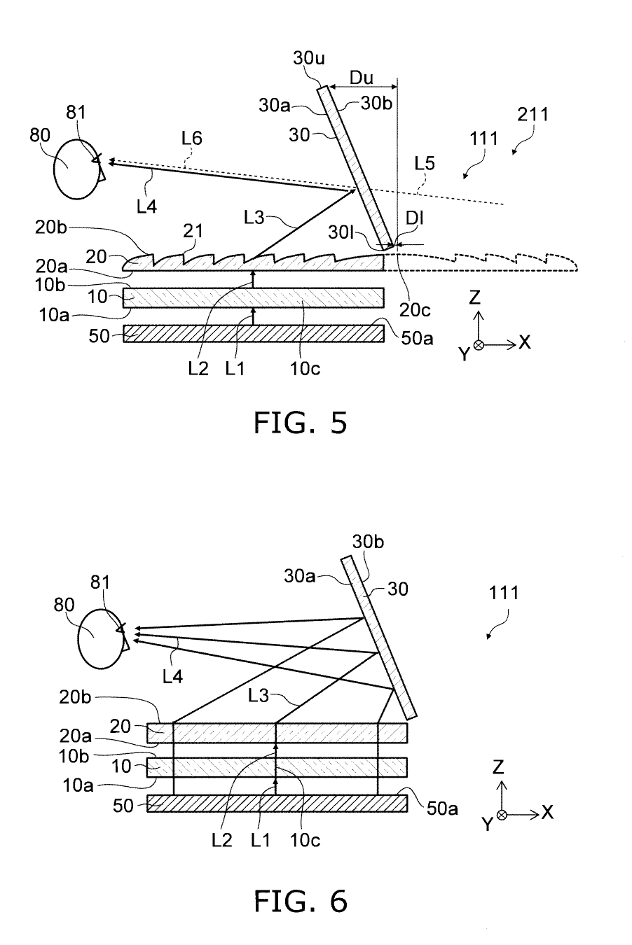

FIG. 5 is a schematic cross-sectional view illustrating the optical device according to the second embodiment.

FIG. 5 is a cross-sectional view taken along line B1-B2 in FIG. 4.

As illustrated in FIGS. 4 and 5, an optical device 111 according to the embodiment includes a first optical element 10 and a second optical element 20. In this example, a third optical element 30 is provided. The third optical element 30 may be included in the optical device 111 or provided separately from the optical device 111.

The optical device 111 is used along with the display 50. For example, the optical device 111 is disposed on the display 50. The display 50 and the optical device 111 are included in a display system 211.

For example, a Fresnel lens may be used in the second optical element 20. With this, a condensing function is obtained. It is possible to change a direction of the optical axis in the second optical element 20 by causing an optical center of the Fresnel lens to be shifted from the center of the first optical element 10.

As illustrated in FIGS. 4 and 5, the second optical element 20 includes a plurality of protruding portions 21. The plurality of protruding portions 21 is provided on at least one of the third surface 20a and the fourth surface 20b. The plurality of protruding portions 21 is provided to have the same center, for example.

Each of the plurality of protruding portions 21 has an arc shape when being projected on the third surface 20a (for example, an X-Y plane). The plurality of protruding portions 21 forms a Fresnel lens.

As illustrated in FIG. 5, the second optical element 20 has an optical center 20c. The optical center 20c is shifted from the center 10c of the first optical element 10. A shift direction is disposed along the first direction (X-axis direction).

The center 10c of the first optical element 10 corresponds to the center of the first optical element 10 in the X-Y plane (a plane including the first direction and the second direction). The optical center 20c of the second optical element 20 is separated from the center 10c of the first optical element 10 in the first direction.

Accordingly, an optical axis of the third light L3 emitted from the second optical element 20 may be tilted with respect to the second light L2 and the third light L3 may be incident to the third optical element 30.

As illustrated in FIG. 5, the optical center 20c of the second optical element 20 may be not provided in the second optical element 20. The optical center 20c may be positioned in a space which is separated from the second optical element 20. For example, the optical center 20c may be estimated from a position at which focuses obtained by causing the collimated light to be incident to the second optical element 20 are linked.

For example, the third optical element 30 includes a lower side part 301 and an upper side part 30u. A distance between the upper side part 30u and the first optical element 10 is longer than a distance between the lower side part 301 and the first optical element 10. At this time, a shift direction of the optical center 20c of the second optical element 20 corresponds to a direction from the upper side part 30u of the third optical element 30 toward the lower side part 301. That is, a distance Du in the first direction between the optical center 20c of the second optical element 20 and the upper side part 30u is longer than a distance D1 in the first direction between the optical center 20c of the second optical element 20 and the lower side part 301.

For example, a direction obtained by projecting a traveling direction of the third light L3 between the second optical element 20 and the third optical element 30 on the first surface 10a (X-Y plane) is the same as a direction obtained by projecting a direction from the upper side part 30u toward the lower side part 301 on the first surface 10a. The direction obtained by projecting the traveling direction of the third light L3 on the first surface 10a is disposed along the direction obtained by projecting the direction from the upper side part 30u toward the lower side part 301 on the first surface 10a.

FIG. 6 is a schematic cross-sectional view illustrating the optical device according to the second embodiment.

As illustrated in FIG. 6, the first light L1 emitted from the display 50 has a component which is disposed along the Z-axis direction. The first light L1 is incident to the first optical element 10 and the second light L2 is emitted from the first optical element 10. A direction of the component which is disposed along the Z-axis direction in the first light L1 is not changed even though the component passes through the first optical element 20. The second light L2 is incident to the second optical element 20 and the third light L3 is emitted from the second optical element 20. The third light L3 is tilted with respect to a Z axis. Three rays of light illustrated in FIG. 6 have a direction which is changed in the third optical element 30. Thus, the three rays of light are, for example, condensed and are incident to the viewer 80 as the fourth light L4.

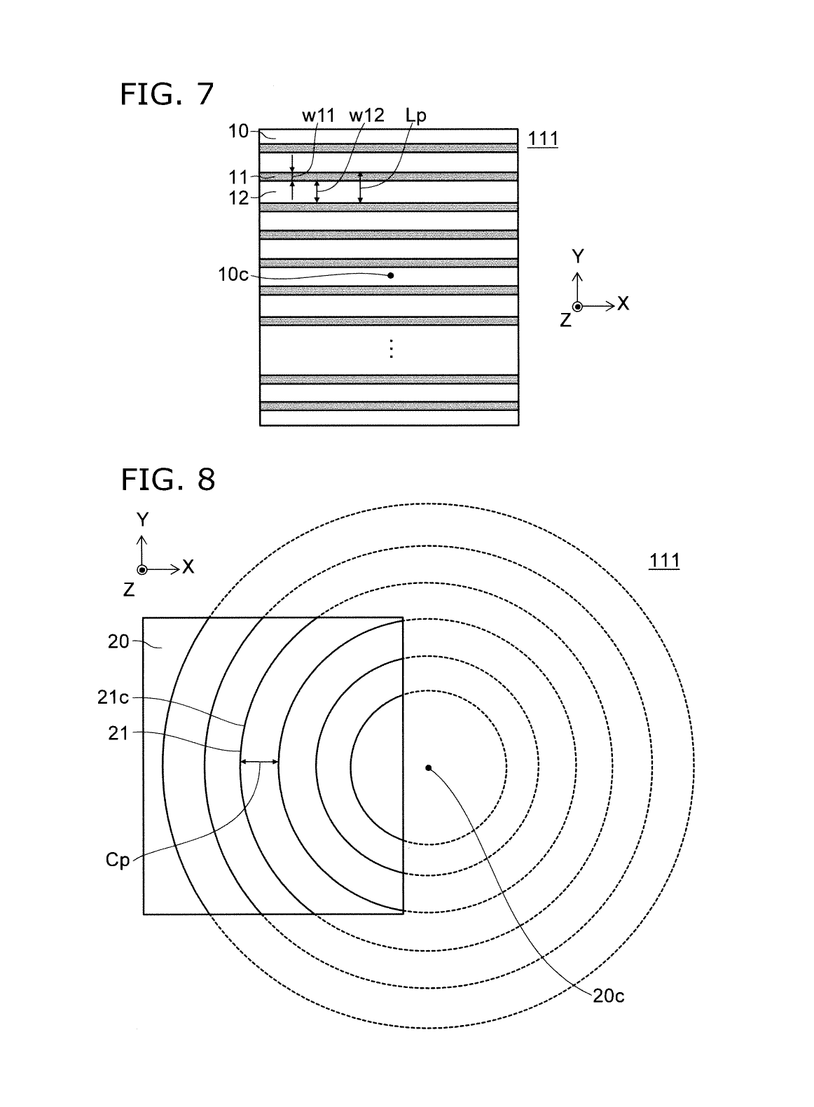

FIG. 7 is a schematic plan view illustrating the optical device according to the second embodiment.

FIG. 7 illustrates the first optical element 10.

As illustrated in FIG. 7, a plurality of transmissive portions 12 and a plurality of non-transmissive portions 11 are provided. For example, at least one of transparent resin and transparent glass is used for each of the plurality of transmissive portions 12. For example, a metallic film is used for each of the plurality of non-transmissive portions 11.

The width w11 of each of the plurality of non-transmissive portions 11 in the second direction (Y-axis direction) is 50 micrometers (μm) or more and 500 μm or less, for example. The width w12 of each of the plurality of transmissive portions 12 in the second direction is 50 μm or more and 500 μm or less, for example. If the width w11 is excessively narrow, for example, manufacturing is difficult. If the width w11 is excessively wide, for example, an extent of blocking transmitted light becomes large, and thus luminance is insufficient and a display function at a time of observation is significantly degraded. If the width w12 is excessively narrow, for example, an extent of blocking transmitted light becomes large and thus luminance is insufficient. If the width w12 is excessively wide, for example, it is difficult to limit a visible area (observation area) as much as desired. As a result, observation by using monocular vision is difficult.

A ratio (w12/Lp) of the width w12 of each of the plurality of transmissive portions 12 in the second direction to a pitch Lp of the plurality of transmissive portions 12 is favorable to be 0.4 or more and 0.8 or less. The ratio (w12/Lp) corresponds to an aperture ratio. If the ratio (w12/Lp) is excessively low, for example, luminance is insufficient. If the ratio (w12/Lp) is excessively high, for example, manufacturing is difficult.

The pitch Lp of the plurality of transmissive portions 12 is the same as a pitch of the plurality of non-transmissive portions 11. The pitch Lp of the plurality of transmissive portions 12 is 50 μm or more and 500 μm or less, for example. If the pitch Lp is excessively small, for example, manufacturing is difficult. If the pitch Lp is excessively large, for example, resolution is insufficient.

FIG. 8 is a schematic plan view illustrating the optical device according to the second embodiment.

FIG. 8 illustrates the second optical element 20.

As illustrated in FIG. 8, a plurality of protruding portions 21 has arc (circular arc) parts in the second optical element 20. That is, at least one of the plurality of protruding portions 21 includes an arc 21c (circular arc). The plurality of protruding portions 21 is provided to have the same center, for example. The center of a concentric circle corresponds to the optical center 20c of the second optical element 20.

A pitch Cp of the plurality of protruding portions 21 is 100 μm or more and 1000 μm or less, for example. If the pitch Cp is excessively small, for example, the diffraction light is incident to both of the eyes and it is impossible to form a desired observation area. For example, monocular vision is not obtained. If the pitch Cp is excessively large, for example, resolution is insufficient.

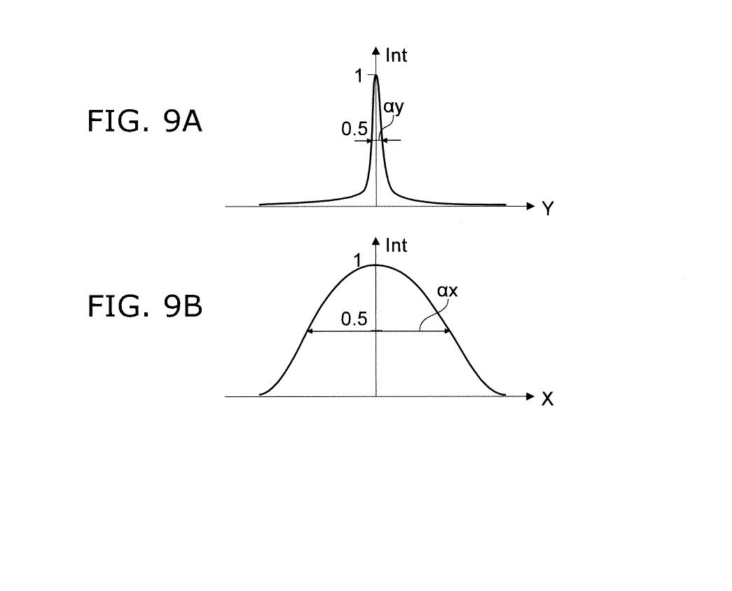

FIGS. 9A and 9B are graphs illustrating characteristics of the optical device according to the second embodiment.

FIGS. 9A and 9B illustrate diffusion of the second light L2 emitted from the first optical element 10. FIG. 9A illustrates diffusion of the light in the Y-axis direction and a transverse axis indicates an angle in the Y-axis direction. FIG. 9B illustrates diffusion of the light in the X-axis direction and a transverse axis indicates an angle in the X-axis direction. A vertical axis indicates relative intensity Int of the light. An angle is obtained using the Z-axis direction as a reference.

As illustrated in FIG. 9A, diffusion of the light in the Y-axis direction is narrow. As illustrated in FIG. 9B, diffusion of the light in the X-axis direction is wide. An angle of full width at half maximum of the second light L2 in the first direction (X-axis direction) is set as a first angle αx. An angle of full width at half maximum of the second light L2 in the second direction (Y-axis direction) is set as a second angle αy. The first angle αx is larger than the second angle αy. That is, the second angle αy is smaller than the first angle αx. The angle of the full width at half maximum corresponds to an angle at which intensity of the light is ½ of the maximum intensity of the light.

The second angle αy is favorable to be 5 degrees or less. With this, for example, it is possible to suppress diffusion of the light and to cause the light to be incident to the one eye 81 of the viewer 80. Preferably, the second angle ay is 3 degrees or less. With this, a state where the light is incident to the one eye 81 is easily maintained even though a position of the viewer 80 is moved.

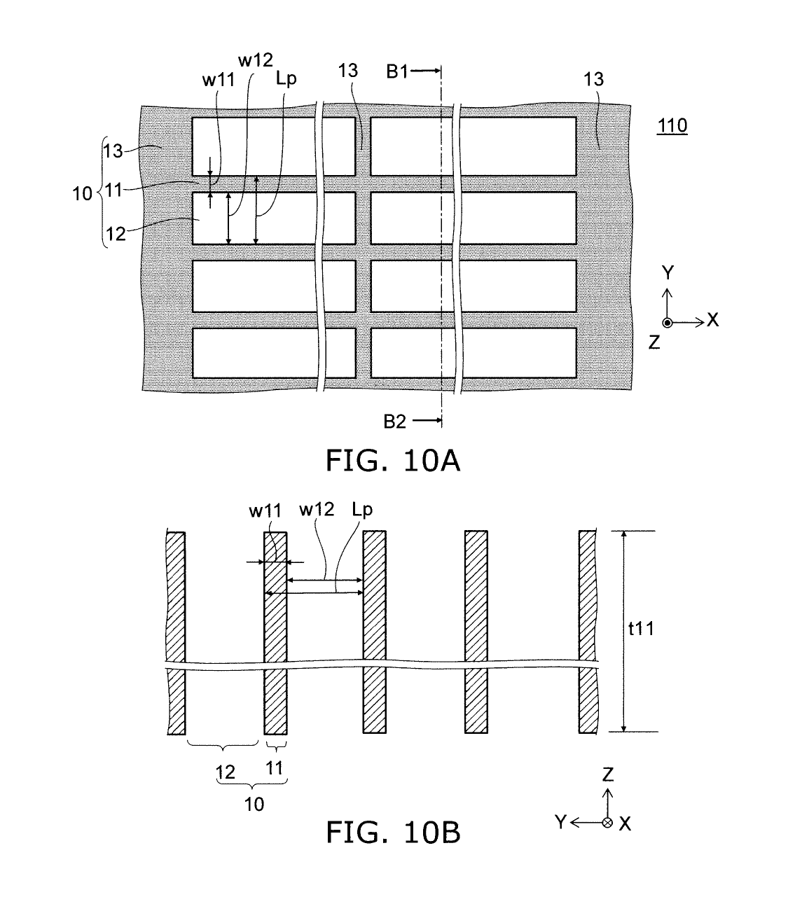

Such characteristics of the first optical element 10 are obtained, for example, by the following configuration and the like. FIGS. 10A and 10B are schematic diagrams illustrating the optical device according to the second embodiment.

FIG. 10A is a schematic plan view illustrating the enlarged first optical element 10.

FIG. 10B is a schematic cross-sectional view.

As illustrated in FIG. 10A, a frame portion 13 is provided in the first optical element 10. The frame portion 13 corresponds to a circumference of the first optical element 10. The plurality of non-transmissive portions 11 is connected to the frame portion 13. The non-transmissive portion 11 is extended in the X-axis direction. In this example, a metallic film is used in the non-transmissive portion 11. The transmissive portion 12 is provided between the non-transmissive portions 11. The transmissive portion 12 corresponds to a gap. The transmissive portion 12 corresponds to an air layer.

Two ends of the non-transmissive portion 11 in the X-axis direction are connected to the frame portion 13. When the length of the non-transmissive portion 11 in the X-axis direction is longer than the width w11 of the non-transmissive portion 11, the non-transmissive portion 11 is likely to bent. In this example, a connection portion 14 is provided between the two ends of the non-transmissive portion 11. The connection portion 14 is extended in the Y-axis direction and is connected to the plurality of non-transmissive portions 11.

For example, the width w11 (length in the Y-axis direction) of the non-transmissive portion 11 is about 100 μm. The width w12 (length in the Y-axis direction) of the transmissive portion 12 is about 303 μm, for example. The pitch Lp of the plurality of transmissive portions 12 (pitch of the plurality of non-transmissive portions 11) is about 403 μm. The width (width in the X-axis direction) of the connection portion 14 is about 100 μm. A plurality of connection portions 14 may be provided. The plurality of connection portions 14 is arranged in the X-axis direction.

The length (length in the X-axis direction) of the non-transmissive portion 11 is about 60 mm, for example. The length of the first optical element in the X-axis direction is about 70 mm, for example. The length of the first optical element 10 in the Y-axis direction is about 110 mm, for example.

As illustrated in FIG. 10B, a thickness t11 (length in the Z-axis direction) of the non-transmissive portion 11 is about 6 mm. The above values are examples and in the embodiment, various changes may be made.

The thickness of the transmissive portion 12 is substantially the same as the thickness t11 of the non-transmissive portion 11. In this example, an aspect ratio of the transmissive portion 12 is substantially t11/w12 and then 20 in this example. It is possible to reduce diffusion of the light in the Y-axis direction by providing the transmissive portion 12 having such a high aspect ratio. In this example, the angle (second angle αy of the full width at half maximum) of diffusion of the light in the second direction (Y-axis direction) is about 3 degrees. In the embodiment, the ratio (aspect ratio) of the width w12 of the transmissive portion 12 in the second direction (Y-axis direction) to the thickness t11 (length in the Z-axis direction) of the non-transmissive portion 11 is favorable to be 10 or more. Accordingly, the second angle ay may be reduced and a desired visible area is obtained.

The angle (diffusion angle) of diffusion of the light is changed by the aspect ratio. The aspect ratio causes an observation area (width of the light which is incident to the viewer 80) in a predetermined observation position to be determined. The aspect ratio may be defined in accordance with the observation position. For example, when a distance (observation distance) between the observation position and the first optical element 10 is appropriately about 100 cm, and the width (right and left width) of the observation area is 5 cm, the aspect ratio is 100 cm/5 cm and then 20. When the observation distance is shorter than that in the above-description, the aspect ratio may be smaller.

When the aspect ratio is excessively low, the observation distance is excessively short. If the observation distance is excessively short, it is difficult to obtain an augmentation effect of depth perception by monocular vision. For example, the observation distance is 21.7 cm or more, favorably 35.5 cm, preferably 614 cm or more, and thus an augmentation effect of the depth perception by the monocular vision is effectively obtained. The observation distance is favorable to be about 50 cm or more, for example. At this time, if the width of the observation area is set to 5 cm such that the light is incident to only one eye, the aspect ratio is 10.

The aspect ratio is favorable to be less than 80. If the aspect ratio is excessively high, a difference between the width of the observation area by a single eye, and the pupil of the eye becomes small and a light blocking area may be overlapped with the pupil. For this reason, display becomes dark. Further, manufacturing is difficult.

The first optical element 10 in this example may be formed in such a manner that the opening corresponding to the transmissive portion 12 is provided on a metallic plate by etching and the like and a plurality of such metallic plates is stacked. A part corresponding to the metallic plate functions as the non-transmissive portion 11. The opening functions as the transmissive portion 12. A light-absorbing film may be formed on a surface of the metallic plate.

In this example, the transmissive portion 12 corresponds to a gap or an air layer, but in the embodiment, an optical transparency resin layer and the like may be used as the transmissive portion 12. When being the air layer, the transmissive portion 12 is favorable to have a function of enabling suppression of light absorption.

The first optical element 10 is also obtained by forming the opening on a thick metallic plate. The first optical element 10 may be formed by injection molding, for example. In the embodiment, a forming method of the first optical element 10 may be arbitrarily determined.

The first optical element 10 may be formed by electroforming. The first optical element 10 may be formed by processing a metallic plate using a laser and forming a slit. For example, dark material having high rigidity is used in the first optical element 10. Painting with a black color may be performed on the first optical element 10.

### Third Embodiment

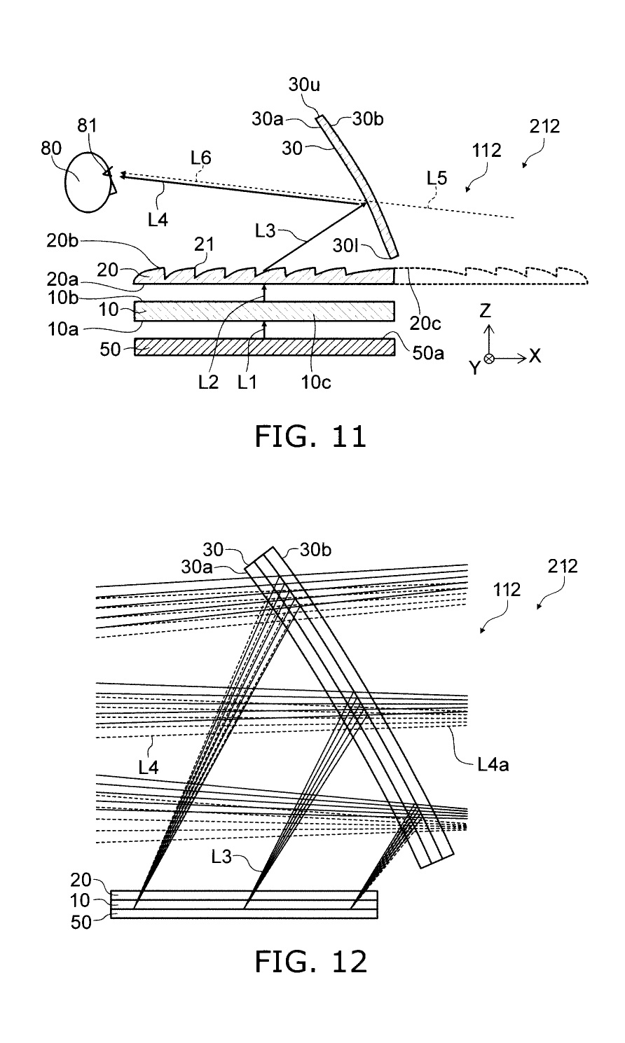

FIG. 11 is a schematic cross-sectional view illustrating an optical device according to a third embodiment.

As illustrated in FIG. 11, an optical device 112 and a display system 212 according to the embodiment also include the first optical element 10 and the second optical element 20. The optical device 112 may include the third optical element 30 or the third optical element 30 may be provided separately from the optical device 112. In the embodiment, the third optical element 30 has optical power. Except for this, the third embodiment may be similar to the second embodiment and thus descriptions thereof will be omitted.

A seventh surface 30a of the third optical element 30 has, for example, a concave surface shape. For example, the third optical element 30 has light condensing properties. The fourth light L4 which is reflected by the third optical element 30 is condensed by the third optical element 30 having power. The viewer 80 observes the condensed fourth light L4. A display image included in the fourth light L4 is enlarged and observed.

FIG. 12 is a schematic cross-sectional view illustrating the optical device according to the third embodiment.

As illustrated in FIG. 12, the third light L3 is reflected by the third optical element 30 and becomes the fourth light L4. The viewer 80 observes a virtual image L4a formed by the fourth light L4.

When the third optical element 30 has power, for example, light condensing characteristics (power) of the second optical element 20 is designed to be appropriate for the power of the third optical element 30.

### Fourth Embodiment

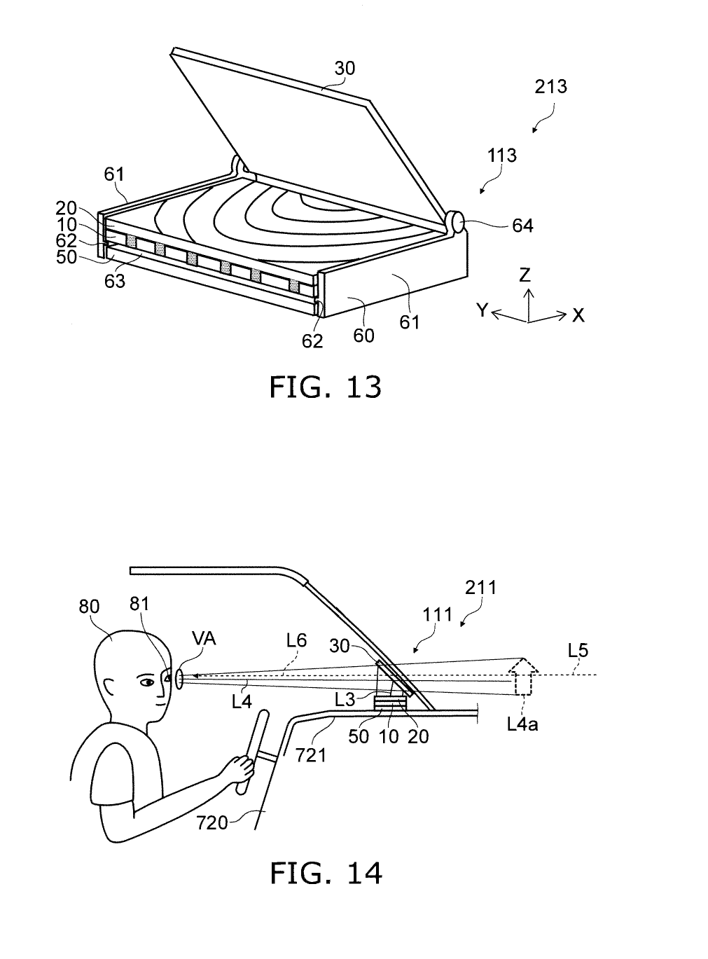

FIG. 13 is a schematic perspective view illustrating an optical device according to a fourth embodiment.

As illustrated in FIG. 13, an optical device 113 and a display system 213 according to the embodiment further include a holder 60. Except for this, the fourth embodiment may be similar to the second and third embodiments, and thus descriptions thereof will be omitted.

The holder 60 is connected to the first optical element 10 and the second optical element 20. The holder 60 integrally supports the first optical element 10 and the second optical element 20. The holder 60 includes a side surface portion 61, a protrusion portion 62, and a joining portion 64. The side surface portion 61 faces a side surface of the first optical element 10 and a side surface of the second optical element 20. The protrusion portion 62 causes a bottom portion of the first optical element 10 to be supported. The joining portion 64 is connected to the side surface portion 61. The joining portion 64 is joined to the third optical element 30. The joining portion 64 causes the third optical element 30 to be dropped and tilted with respect to the first optical element 10 and then to be supported.

Two side surface portions 61 are provided in the holder 60. The two side surface portions 61 are separated from each other in the Y-axis direction. The protrusion portion 62 is provided on each of the two side surface portions 61. A space 63 is provided on a lower portion of the first optical element 10, between the two side surface portions 61. The display 50 is inserted into the space 63. The display 50 may have a state of being inserted into the space 63 and a state of being extracted from the space 63.

The holder 60 regulates a spatial arrangement between the display 50 and at least one of the first optical element 10 and the second optical element 20. For example, positions of the first optical element 10 and the second optical element 20 are defined by the two side surface portions 61 and the two protrusion portions 62. The two side surface portions 61 cause a position of the display 50 to be defined. The holder 60 holds the display 50 attachably and removably.

Hereinafter, an example of a using state of the optical device according to the embodiment will be described. An example of the optical device 111 will be described below. The following descriptions may be applied to any optical device and a variation according to the above-described embodiments.

FIG. 14 is a schematic cross-sectional view illustrating a using state of the optical device according to the embodiment.

As illustrated in FIG. 14, the optical device 111 according to the embodiment may be mounted on the moving body 720 and used. The moving body 720 may arbitrarily correspond to a vehicle, a train, a ship, an airplane, and the like. The viewer 80 rides the moving body 720. The moving body 720 has a console (dashboard and the like) 721. The display 50 is disposed on the console 721, and the first optical element 10 and the second optical element 20 are disposed on the display 50.

The diffusion of the fourth light L4 which is reflected by the third optical element 30 is limited. Luminous flux of the fourth light L4 forms a visible area VA. A distance between the right eye (pupil) and the left eye (pupil) of the viewer 80 is, for example, 60 mm or more and 75 mm or less and for example, about 65 mm. The width of the visible area VA in the crosswise direction is, for example, 75 mm or less and, for example, 65 mm or less. That is, the width of the fourth light L4 in the crosswise direction in a position of the eye 81 of the viewer 80 is 75 mm or less, and for example, 65 mm or less. A state where the fourth light L4 is incident to the one eye 81 of the viewer 80 and is not incident to another eye is formed. The viewer 80 observes the virtual image L4a by the fourth light L4 with the one eye 81.

The fifth light L5 including the background image passes through the third optical element 30 and is incident to the viewer 80 as the sixth light L6. The background image includes an image of a road ahead of the moving body 720 (vehicles or the like). A display image includes a figure such as an arrow, a character for navigation, and the like. The display image is superposed on the background image and is perceived with the one eye 81, and thus a depth position of the display image is augmented and perceived.

According to the embodiments, for example, a portable display 50 (for example, a smart phone or the like) may be carried on a vehicle and be used as a navigation apparatus. The display 50 is disposed on the console 721 and, for example, substantially horizontally disposed. The third optical element 30 is disposed to be perpendicular or tilted in order to observe the background image through the third optical element 30. The second optical element 20 is used for causing the light from the display 50 which is disposed substantially horizontally to be incident to the third optical element 30. Thus, the first optical element 10 for limiting diffusion of the light is used for causing the light to be incident on the one eye 81 of the viewer 80. The diffusion of the light is further controlled by the second optical element 20 having light condensing properties. The display 50 may be not disposed strictly horizontally.

The optical axis is tilted in the second optical element 20. Thereby, an incident angle in the third optical element 30 may be reduced. For example, when the third optical element 30 is a combiner (also including a concave Fresnel mirror) having a concave surface shape, if the incident angle is large, an image is distorted. It is possible to reduce the incident angle in the third optical element 30 and to approach a state perpendicular to the third optical element 30, by causing the optical axis to be tilted in the second optical element 20. It is possible to reduce the size of a planar combiner by the third optical element 30 causing the incident angle in the combiner to be reduced.

According to the embodiments, there is provided an optical device that enables a new application of a display.

In the specification of the application, “perpendicular” and “parallel” refer to not only strictly perpendicular and strictly parallel but also include, for example, the fluctuation due to manufacturing processes, etc. It is sufficient to be substantially perpendicular and substantially parallel.

Hereinabove, embodiments of the invention are described with reference to specific examples. However, the invention is not limited to these specific examples. For example, one skilled in the art may similarly practice the invention by appropriately selecting specific configurations of components such as the first optical element, the second optical element, the third optical element, the holder and the display, etc., from known art; and such practice is within the scope of the invention to the extent that similar effects can be obtained.

Further, any two or more components of the specific examples may be combined within the extent of technical feasibility and are included in the scope of the invention to the extent that the purport of the invention is included.

Moreover, all optical devices practicable by an appropriate design modification by one skilled in the art based on the optical devices described above as embodiments of the invention also are within the scope of the invention to the extent that the spirit of the invention is included.

Various other variations and modifications can be conceived by those skilled in the art within the spirit of the invention, and it is understood that such variations and modifications are also encompassed within the scope of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. An optical device comprising:
a first optical element being to be disposed on a display surface of a display, the first optical element including
a first surface, a first light emitted from the display surface being incident on the first surface, and
a second surface being opposite to the first surface,
the first optical element including a plurality of transmissive portions and a plurality of non-transmissive portions,
each of the transmissive portions extending in a first direction parallel with the first surface,
the transmissive portions being arranged in a second direction perpendicular to the first direction and parallel with the first surface,
each of the non-transmissive portions being disposed between the transmissive portions,
a light transmittance of the non-transmissive portions being lower than a light transmittance of the transmissive portions; and
a second optical element disposed on the first optical element, a second light emitted from the second surface being incident on the second optical element, the second optical element emitting the second light as a third light, the second optical element causing an optical axis of the third light to be tilted with respect to an optical axis of the second light in a plane perpendicular to the second direction.

2. The device according to claim 1, wherein
the second optical element has
a third surface, the second light being incident on the third surface, and
a fourth surface being opposite to the third surface,
the second optical element includes a plurality of protruding portions, the protruding portions being provided on at least one of the third surface and the fourth surface,
one of the protruding portions includes
a first tilted surface being tilted with respect to the first surface and being disposed along the second direction, and
a second tilted surface being tilted with respect to the first surface, the second tilted surface intersecting with the first tilted surface and being disposed along the second direction,
an angle between the first surface and the first tilted surface is different from an angle between the first surface and the second tilted surface.

3. The device according to claim 1, wherein
the second optical element includes
a first part having a third surface, the second light being on the third surface and a fourth surface being opposite to the third surface, and
a second part having a fifth surface facing the fourth surface and a sixth surface being opposite to the fifth surface,
the first part includes a plurality of first protruding portions, the first protruding portions being provided on at least one of the third surface and the fourth surface,
the second part includes a plurality of second protruding portions, the second protruding portions being provided on at least one of the fifth surface and the sixth surface,
one of the first protruding portions includes
a first tilted surface being tilted with respect to the first surface and being disposed along the second direction, and
a second tilted surface being tilted with respect to the first surface, the second tilted surface intersecting with the first tilted surface and being disposed along the second direction,
an angle between the first surface and the first tilted surface is different from an angle between the first surface and the second tilted surface, and
each of the second protruding portions has an arc shape when projected onto the third surface.

4. The device according to claim 1, wherein
the second optical element has
a third surface, the second light being incident on the third surface, and
a fourth surface being opposite to the third surface,
the second optical element includes a plurality of protruding portions, the protruding portions being provided on at least one of the third surface and the fourth surface,
each of the protruding portions has an arc shape when projected onto the third surface, and
an optical center of the second optical element is separated from a center of the first optical element in the first direction in a plane including the first direction and the second direction.

5. The device according to claim 4, wherein
the protruding portions form a Fresnel lens.

6. The device according to claim 4, wherein
the second optical element emits the third light toward a third optical element provided to be tilted with respect to the first surface,
the third optical element has a seventh surface and an eighth surface being opposite to the seventh surface,
the third light is reflected by the seventh surface,
light including a background image is incident on the eighth surface, passes through the third optical element, is emitted from the seventh surface, and travels toward an viewer of the display, and
the third light is reflected by the third optical element and is incident on one eye of the viewer.

7. The device according to claim 6, further comprising
the third optical element.

8. The device according to claim 6, wherein
the third optical element includes a lower portion and an upper portion,
a distance between the upper portion and the first optical element is longer than a distance between the lower portion and the first optical element, and
a distance along the first direction between the optical center of the second optical element and the upper portion is longer than a distance along the first direction between the optical center of the second optical element and the lower portion.

9. The device according to claim 6, wherein
the third optical element includes a lower portion and an upper portion,
a distance between the upper portion and the first optical element is longer than a distance between the lower portion and the first optical element, and
a traveling direction of the third light between the second optical element and the third optical element when projected onto the first surface is disposed along a direction from the upper portion to the lower portion when projected onto the first surface.

10. The device according to claim 1, wherein
a full width at half maximum of the second light in the first direction is larger than a full width at half maximum of the second light in the second direction.

11. The device according to claim 10, wherein
a first angle of the full width at half maximum of the second light in the first direction is larger than a second angle of the full width at half maximum of the second light in the second direction, and
the second angle is 5 degrees or less.

12. The device according to claim 10, wherein
a first angle of the full width at half maximum of the second light in the first direction is larger than a second angle of the full width at half maximum of the second light in the second direction, and
the second angle is 3 degrees or less.

13. The device according to claim 1, further comprising
a holder connected to the first optical element and the second optical element,
the holder regulating a spatial arrangement between the display and at least one of the first optical element and the second optical element.

14. The device according to claim 13, wherein
the holder holds the display attachably and removably.

15. The device according to claim 1, wherein
each of the transmissive portions includes at least one of transparent resin and transparent glass.

16. The device according to claim 15, wherein
each of the non-transmissive portions includes metal.

17. The device according to claim 1, wherein
a pitch of the transmissive portions is 50 micrometers or more and 500 micrometers or less, and
a pitch of the protruding portions is 100 micrometers or more and 1000 micrometers or less.

18. The device according to claim 1, wherein
a ratio of a width of each of the transmissive portions in the second direction to a pitch of the plurality of transmissive portions is 0.4 or more and 0.8 or less.
